(19) United States
(12) Patent Application Publication
(10) Pub. No.: US 2015/0139086 A1
(43) Pub. Date: May 21, 2015

(54) COMMUNICATION SYSTEM AND COMMUNICATION CONTROL METHOD

(71) Applicant: Kenichi Murakami, Osaka-shi (JP)

(72) Inventor: Kenichi Murakami, Osaka-shi (JP)

(73) Assignee: SUMITOMO ELECTRIC INDUSTRIES, LTD., Osaka-shi, Osaka (JP)

(21) Appl. No.: 14/118,568

(22) PCT Filed: Feb. 22, 2012
(86) PCT No.: PCT/JP2012/054285

§ 371 Date: Nov. 19, 2013

(30) Foreign Application Priority Data
Jun. 1, 2011 (JP) 2011-123275

(51) Int. Cl. H04L 29/12; H04W 8/26

(52) U.S. Cl. CPC H04L 61/2007; H04W 8/26
USPC 370/329

(57) ABSTRACT

In a communication system 301, a wireless base station device 111 transmits inquiry information for acquiring an address of an internal network connection device 102 to a communication management device 103. The communication management device 103 receives the inquiry information, and transmits response information indicating the address of the internal network connection device 102 to the wireless base station device 111. The wireless base station device 111 includes the address of the internal network connection device 102 indicated by the response information received from the communication management device 103, in access request information indicating a request for access to an internal network 51 by a wireless terminal device 150, and transmits the access request information to the communication management device 103.

### TECHNICAL FIELD

The present invention relates to a communication system and a communication control method. More particularly, the present invention relates to a communication system and a communication control method which allow a wireless terminal device to access an internal network via a wireless base station device.

### BACKGROUND ART

In conventional mobile communication systems, communication services have been provided by wireless base station devices (hereinafter also referred to as macro base stations or eNBs (e NodeBs)) each forming a cell having a radius ranging from several hundreds of meters to several tens of kilometers, i.e., an area in which wireless terminal devices are allowed to communicate with the wireless base station device.

In recent years, with a dramatic increase in the number of subscribers of mobile communication services and an increase in communication traffic due to data communication, it is desired to distribute the subscribers and the communication traffic over cells having smaller radii, and to reliably provide users with a certain level of communication speed. Further, as a countermeasure against blind zones caused by skyscrapers, it is desired to install wireless base station devices in office floors and ordinary houses.

In association with these requirements, downsizing of wireless base station devices has progressed by remarkable improvement in throughput of various devices used in the wireless base station devices, and downsized base stations have attracted attention.

Such downsized base stations (hereinafter also referred to as femto base stations or HeNBs (Home e NodeBs)) form femto cells, and each femto cell has a radius as small as about 10 meters. Therefore, it is considered that the femto base stations are used in places outside macro cells formed by macro base stations, or places where it is difficult to install macro base stations, such as homes, underground malls, and the like.

As a function of a wireless terminal device (hereinafter also referred to as a UE (User Equipment)) to access a terminal device provided in a LAN (Local Area Network) via such a HeNB, LIPA (Local IP Access) is defined in 3GPP (Third Generation Partnership Project).

The LIPA is a function that allows a UE to access a LAN by using not a global IP (Internet Protocol) address allocated from a mobile communications carrier network but a local IP address for accessing the LAN.

For example, Non-Patent Literature 1 (3GPP SPEC 23.829 V1.3.0 2010.9) discloses a local gateway device (hereinafter also referred to as an L-GW). When a UE accesses a terminal device in a LAN via a HeNB, an L-GW provides a local IP address to the UE, and performs a data relaying process or the like.

The LIPA is used, for example, when a user downloads a video file from a hard disk recorder in a home LAN onto a cellular phone to watch a program.

### CITATION LIST

### Non Patent Literature

Non-Patent Literature 1: 3GPP SPEC 23.829 V1.3.0 2010.9

### SUMMARY OF INVENTION

### Technical Problem

By the way, the L-GW establishes a communication connection using an S5 interface with an S-GW (Serving Gateway). Therefore, for the S-GW, the L-GW is positioned similarly to a P-GW (Packet Data Network Gateway).

Accordingly, in a connection procedure in which a UE acquires a local IP address and accesses a LAN, exchange of control messages is not performed between an HeNB and an L-GW, but exchange of control messages is performed between an MME (Mobility Management Entity) located on an EPC (Evolved Packet Core) side and the HeNB as in a usual connection procedure to acquire a global IP address.

The MME confirms APN (Access Point Name) or LIPA Indication for LIPA which is specified by the UE, and establishes a session with the L-GW via the S-GW if the LIPA is applicable. Thereby, PDN connection for the LIPA is established.

Further, the HeNB includes an address of the L-GW, e.g., IPv4 address or IPv6 address, in a connection request message to be transmitted from the UE to the MME in order to acquire a local IP address from the L-GW. Thereby, the S-GW recognizes the L-GW with which a session is to be established.

In Rel (Release)-11 of 3GPP, in addition to the function described in Non-Patent Literature 1 which is Rel-10, a function for continuing LIPA connection even when a UE moves between HeNBs is studied.

This function fundamentally envisions an environment such as an intra-company system in which a plurality of HeNBs are installed. In order to realize this function in a communication system, an L-GW collocated in an HeNB in the Rel-10, e.g., an L-GW incorporated in an HeNB, is separated from the HeNB to be installed as a standalone L-GW in the Rel-11.

In such a communication system, an appropriate method is desired which allows a newly installed HeNB to acquire an IP address of an L-GW to be included in a connection request message.

The present invention is made to solve the above problem and has an object to provide a communication system and a communication control method which allow a wireless base station device to appropriately acquire an address of an internal network connection device connected between the wireless base station device and an internal network.

### Solution to Problem

(1) In order to solve the above-mentioned problem, a communication system according to one aspect of the present invention includes: a wireless base station device that transmits and receives radio signals to and from a wireless terminal device; an internal network connection device connected between the wireless base station device and the internal network; and a communication management device that manages the wireless terminal device, the wireless base station device, and the internal network connection device. The wireless base station device transmits inquiry information for acquiring an address of the internal network connection device to the communication management device. The communication management device receives the inquiry information, and transmits response information indicating the address of the internal network connection device to the wireless base station device. The wireless base station device includes the address of the internal network connection device indicated by the response information received from the communication management device, in access request information indicating a request for access to the internal network by the wireless terminal device, and transmits the access request information to the communication management device. The communication management device acquires, from the internal network connection device, an address allocated to the wireless terminal device by the internal network connection device having the address indicated by the access request information, and notifies the wireless terminal device of the acquired address via the wireless base station device.

According to the above configuration, in contrast to a configuration in which a newly installed wireless base station device broadcasts inquiry information to other devices in a subsystem including, for example, wireless base station devices, an internal network connection device, and an internal network, it is possible to prevent an increase in traffic due to concurrent responses from the other devices. Further, since the communication management device is adopted, address resolution of the internal network connection device can be performed more reliably. Accordingly, the wireless base station device can appropriately acquire the address of the internal network connection device connected between the wireless base station device and the internal network.

(2) Preferably, the wireless base station device includes, in the inquiry information, identification information for identifying the internal network connection device corresponding to the wireless base station device, and transmits the inquiry information to the communication management device. The communication management device receives the inquiry information, and transmits, to the wireless base station device, based on the identification information, response information indicating the address of the internal network connection device corresponding to the wireless base station device.

According to the above configuration, the communication management device is allowed to easily identify the internal network connection device corresponding to the wireless base station device that has transmitted the inquiry information.

(3) Preferably, the communication management device receives the inquiry information, and acquires the address of the internal network connection device from an address management device for managing the address of the internal network connection device.

According to the above configuration, it is possible to resolve the address of the internal network connection device without using a device in a subsystem that is an environment on the customer side of a mobile communications carrier, thereby providing more appropriate communication services.

(4) Preferably, the communication management device receives the inquiry information, and acquires the address of the internal network connection device from another wireless base station device that has already established communication connection using a predetermined logical interface with the internal network connection device.

According to the above configuration, it is possible to perform address resolution by a device in a subsystem including an internal network connection device, thereby simplifying the address acquisition procedure.

(5) A communication system according to another aspect of the present invention includes: a plurality of wireless base station devices that transmit and receive radio signals to and from wireless terminal devices; an internal network connection device connected between the plurality of wireless base station devices and an internal network; and a communication management device that manages the wireless terminal devices, the plurality of wireless base station devices, and the internal network connection device. One of the wireless base station devices transmits inquiry information for acquiring an address of the internal network connection device, to another one of the wireless base station devices that has already established communication connection using a predetermined logical interface with the wireless base station device, via the predetermined logical interface. The another wireless base station device receives the inquiry information, and transmits response information indicating the address of the internal network connection device to the wireless base station device via the predetermined logical interface. The wireless base station device includes the address of the internal network connection device indicated by the response information received from the another wireless base station device, in access request information indicating a request for access to the internal network by the wireless terminal device, and transmits the access request information to the communication management device. The communication management device acquires, from the internal network connection device, an address allocated to one of the wireless terminal devices by the internal network connection device having the address indicated by the access request information, and notifies the wireless terminal device of the acquired address via the wireless base station device.

According to the above configuration, it is possible to perform address resolution by a device in a subsystem including an internal network connection device, thereby simplifying the address acquisition procedure.

(6) Preferably, the wireless base station device transmits the inquiry information to another one of the wireless base station devices that has already established communication connection using a predetermined logical interface with the wireless base station device, and belongs to the same subscriber group as the wireless base station device.

According to the above configuration, it is possible to prevent the inquiry information from being unnecessarily transmitted to many wireless base station devices.

(7) Preferably, the wireless base station device includes, in the inquiry information, identification information for identifying the internal network connection device corresponding to the wireless base station device, and transmits the inquiry information to the another wireless base station. The another wireless base station device receives the inquiry information, and transmits, to the wireless base station device, based on the identification information, response information indicating the address of the internal network connection device corresponding to the wireless base station device.

According to the above configuration, the wireless base station device to which the inquiry information has been transmitted is allowed to easily identify the internal network connection device corresponding to the wireless base station device from which the inquiry information has been transmitted.

(8) Preferably, in a state where the wireless base station device is communicating with the internal network connection device without establishing communication connection using a predetermined logical interface, if the wireless base station device receives an inquiry about the address of the internal network connection device from another wireless base station device directly or via another device, the wireless base station device establishes the communication connection with the internal network connection device.

As described above, in the case where the collocated internal network connection device is made standalone, communication connection using the same logical interface as that between the new wireless base station device and the internal network connection device is also established between the existing wireless base station device and the internal network connection device. Thereby, the communication procedure between each wireless base station device and the internal network connection device in the subsystem can be unified, and the communication process can be simplified.

(9) Preferably, the wireless base station device is an HeNB (Home e NodeB) defined in 3GPP, the internal network connection device is an L-GW (Local Gateway) defined in 3GPP, and the communication management device is an MME (Mobility Management Entity) defined in 3GPP.

According to the above configuration, in order to realize the LIPA function defined in 3GPP, the wireless base station device can appropriately acquire the address of the internal network connection device connected between the wireless base station device and the internal network.

(10) In order to solve the above-mentioned problem, a communication control method according to one aspect of the present invention is a communication control method in a communication system including: a wireless base station device that transmits and receives radio signals to and from a wireless terminal device; an internal network connection device connected between the wireless base station device and the internal network; and a communication management device that manages the wireless terminal device, the wireless base station device, and the internal network connection device. The method includes the steps of: the wireless base station device transmitting inquiry information for acquiring an address of the internal network connection device to the communication management device; the communication management device receiving the inquiry information, and transmitting response information indicating the address of the internal network connection device to the wireless base station device; the wireless base station device including the address of the internal network connection device indicated by the response information received from the communication management device, in access request information indicating a request for access to the internal network by the wireless terminal device, and transmitting the access request information to the communication management device; and the communication management device acquiring, from the internal network connection device, an address allocated to the wireless terminal device by the internal network connection device having the address indicated by the access request information, and notifying the wireless terminal device of the acquired address via the wireless base station device.

According to the above configuration, in contrast to a configuration in which a newly installed wireless base station device broadcasts inquiry information to other devices in a subsystem including, for example, wireless base station devices, an internal network connection device, and an internal network, it is possible to prevent an increase in traffic due to concurrent responses from the other devices. Further, since the communication management device is adopted, address resolution of the internal network connection device can be performed more reliably. Accordingly, the wireless base station device can appropriately acquire the address of the internal network connection device connected between the wireless base station device and the internal network.

(11) A communication control method according to another aspect of the present invention is a communication control method in a communication system including: a plurality of wireless base station devices that transmit and receive radio signals to and from wireless terminal devices; an internal network connection device connected between the plurality of wireless base station devices and an internal network; and a communication management device that manages the wireless terminal devices, the plurality of wireless base station devices, and the internal network connection device. The method includes the steps of: one of the wireless base station devices transmitting inquiry information for acquiring an address of the internal network connection device, to another one of the wireless base station devices that has already established communication connection using a predetermined logical interface with the wireless base station device, via the predetermined logical interface; the another wireless base station device receiving the inquiry information, and transmitting response information indicating the address of the internal network connection device to the wireless base station device via the predetermined logical interface; the wireless base station device including the address of the internal network connection device indicated by the response information received from the another wireless base station device, in access request information indicating a request for access to the internal network by the wireless terminal device, and transmitting the access request information to the communication management device, and the communication management device acquiring, from the internal network connection device, an address allocated to one of the wireless terminal devices by the internal network connection device having the address indicated by the access request information, and notifying the wireless terminal device of the acquired address via the wireless base station device.

According to the above configuration, address resolution can be performed by a device in the subsystem including the internal network connection device, thereby simplifying the address acquisition procedure.

### Advantageous Effects of Invention

According to the present invention, a wireless base station device can appropriately acquire an address of an internal network connection device connected between the wireless base station device and an internal network.

### BRIEF DESCRIPTION OF DRAWINGS

FIG.1 is a diagram showing a configuration of a wireless communication system according to Embodiment 1 of the present invention.

FIG. 2 is a diagram showing an issue that arises in a case where an HeNB is newly added in an HeNB subsystem 201 according to Embodiment 1 of the present invention.

FIG. 3 is a diagram showing an interface establishment operation between a new HeNB and an L-GW in the wireless communication system according to Embodiment 1 of the present invention.

FIG. 4 is a diagram showing a sequence to establish an interface between a new HeNB and an L-GW in the wireless communication system according to Embodiment 1 of the present invention.

FIG. 5 is a diagram showing an example of a sequence to establish an LIPA connection in the wireless communication system according to Embodiment 1.

FIG. 6 is a diagram showing an interface establishment operation between a new HeNB and an L-GW in a wireless communication system according to Embodiment 2 of the present invention.

FIG. 7 is a diagram showing a sequence to establish an interface between a new HeNB and an L-GW in the wireless communication system according to Embodiment 2 of the present invention.

FIG. 8 is a diagram showing an interface establishment operation between a new HeNB and an L-GW in a wireless communication system according to Embodiment 3 of the present invention.

FIG. 9 is a diagram showing a sequence to establish an interface between a new HeNB and an L-GW in the wireless communication system according to Embodiment 3 of the present invention.

FIG. 10 is a diagram showing establishment of an interface between an existing HeNB and an L-GW in a wireless communication system according to Embodiment 4 of the present invention.

FIG. 11 is a diagram showing an example of a sequence to establish an interface between an HeNB and an L-GW in the wireless communication system according to Embodiment 4 of the present invention.

FIG. 12 is a diagram showing another example of a sequence to establish an interface between an existing HeNB and an L-GW in the wireless communication system according to Embodiment 4 of the present invention.

### DESCRIPTION OF EMBODIMENTS

Hereinafter, embodiments of the present invention will be described with reference to the drawings. In the drawings, the same or corresponding parts are denoted by the same reference numerals, and will not be repeatedly described.

### Embodiment 1

### [Configuration and Fundamental Operation]

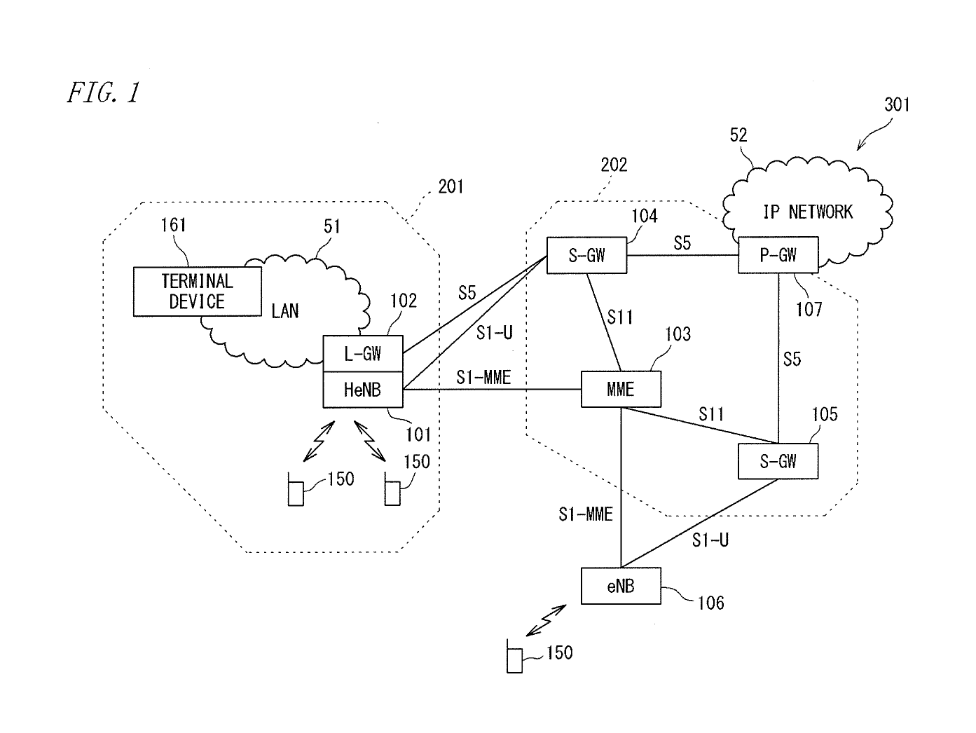

FIG. 1 is a diagram illustrating a configuration of a wireless communication system according to Embodiment 1 of the present invention.

With reference to FIG. 1, a wireless communication system 301 is, for example, a mobile communication system that complies with LTE (Long Term Evolution) standardized by 3GPP, and includes an HeNB subsystem 201, an EPC (mobile communications carrier network) 202, and an eNB (wireless base station device) 106. The HeNB subsystem 201 includes an HeNB (wireless base station device) 101, an L-GW (internal network connection device) 102, and a LAN (internal network) 51. The EPC 202 includes an MME (communication management device) 103, S-GWs (communication control devices) 104 and 105, and a P-GW 107. The L-GW 102 and the HeNB 101 may be housed in the same casing or different casings.

The HeNB 101 and the eNB 106 transmit and receive radio signals to and from UEs 150 to communicate with the UEs 150.

The L-GW 102 is connected between the HeNB 101 and the LAN 51. The L-GW 102 is able to provide LIPA connections to a plurality of UEs. The L-GW 102 allocates, to each UE, its own resource for communication with a terminal device 161 in the LAN 51.

Specifically, the L-GW 102 provides a local IP address to the UE 150, and performs a data relaying process and the like when the UE 150 accesses the terminal device 161 in the LAN 51 via the HeNB 101. That is, the L-GW 102 transmits, to the terminal device 161 in the LAN 51, data received from the UE 150 via the HeNB 101, and transmits, to the UE 150, via the HeNB 101, data received from the terminal device 161 in the LAN 51.

The HeNB 101 and the L-GW 102 each have the LIPA function defined in the 3GPP, and enable communication between the UE 150 and the terminal device 161 in the LAN 51.

The S-GW 104 is connected between the HeNB 101 and an IP network (external network) 52. The S-GW 104 transmits, to the IP network 52, via the P-GW 107, data received from the UE 150 via the HeNB 101, and transmits, to the UE 150, via the HeNB 101, data received from another device in the IP network 52 via the P-GW 107.

The MME 103 manages the UEs, the HeNB, the eNB, the L-GW and the like in the wireless communication system 301. The MME 103 transmits and receives control messages to and from the HeNB 101, and transmits and receives control messages to and from the eNB 106.

The HeNB 101 transmits and receives IP packets to and from the IP network 52 via the S-GW 104 and the P-GW 107.

The eNB 106 transmits and receives IP packets to and from the IP network 52 via the S-GW 105 and the P-GW 107.

The HeNB 101 and the S-GW 104 mutually transmit and receive communication data that conforms to an S1-U interface as a logical interface, thereby exchanging various kinds of information via the S1-U interface.

The HeNB 101 and the MME 103 mutually transmit and receive communication data that conforms to an S1-MME interface as a logical interface, thereby exchanging various kinds of information via the S1-MME interface.

The eNB 106 and the S-GW 105 mutually transmit and receive communication data that conforms to an S1-U interface as a logical interface, thereby exchanging various kinds of information via the S1-U interface.

The eNB 106 and the MME 103 mutually transmit and receive communication data that conforms to an S1-MME interface as a logical interface, thereby exchanging various kinds of information via the S1-MME interface.

The L-GW 102 and the S-GW 104 mutually transmit and receive communication data that conforms to an S5 interface as a logical interface, thereby exchanging various kinds of information via the S5 interface.

The MME 103 and each of the S-GWs 104 and 105 mutually transmit and receive communication data that conforms to an S11 interface as a logical interface, thereby exchanging various kinds of information via the S11 interface.

The P-GW 107 and each of the S-GWs 104 and 105 mutually transmit and receive communication data that conforms to an S5 interface as a logical interface, thereby exchanging various kinds of information via the S5 interface.

### [Issue Related to LIPA in Rel-11]

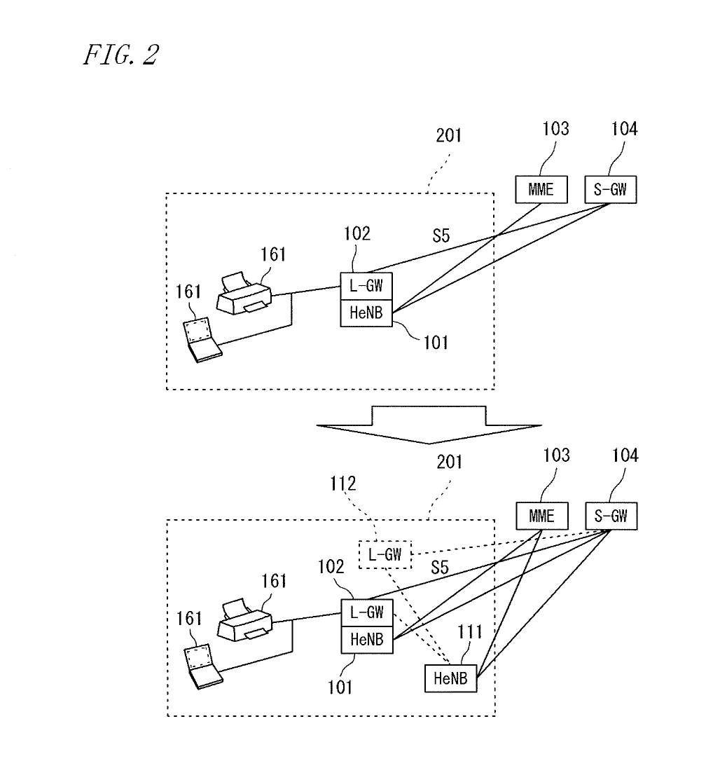

FIG. 2 is a diagram showing an issue that arises when an HeNB is newly added in the HeNB subsystem 201 according to Embodiment 1 of the present invention.

With reference to an upper part of FIG. 2, in the case of the LIPA in the Rel-11, the L-GW becomes a standalone L-GW separated from the HeNB. Therefore, when the HeNB 101 corresponding to the LIPA in the Rel-10 exists in the HeNB subsystem 201, it will be an issue how to handle the L-GW 102 collocated in the HeNB 101.

That is, with reference to a lower part of FIG. 2, when an HeNB 111 is newly added, it will be an issue whether the collocated L-GW 102 should be used as it is or the L-GW 102 should be used as a standalone L-GW 112.

There is a similar issue also in a case where a new HeNB is added in the HeNB subsystem 201 wherein not a collocated L-GW but a standalone L-GW has already existed.

Hereinafter, a description will be given of an operation to configure an HeNB network in the case where an HeNB is added in an HeNB subsystem wherein a collocated L-GW exists.

### [Operation]

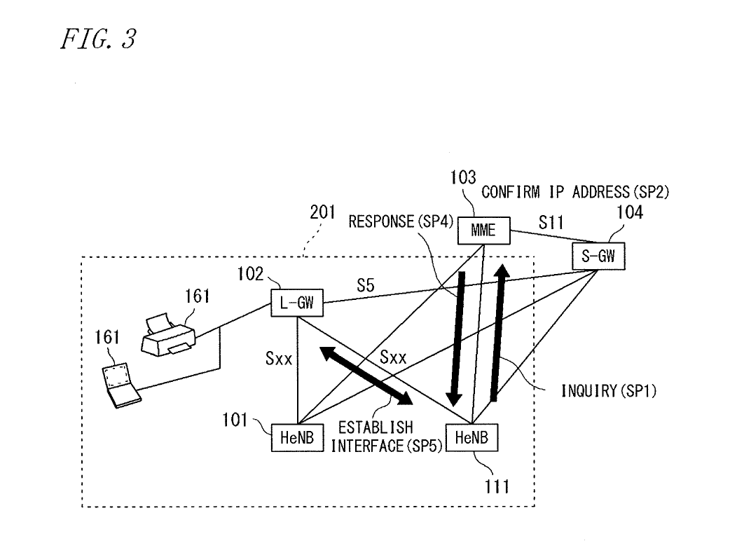

FIG. 3 is a diagram showing an interface establishment operation between a new HeNB and an L-GW in the wireless communication system according to Embodiment 1 of the present invention.

With reference to FIG. 3, even when the L-GW in the HeNB subsystem 201 is a collocated L-GW, the L-GW has already been separated from the HeNB to be a standalone L-GW except for an initial state where only one HeNB in which the L-GW is collocated exists in the HeNB subsystem 201. A case where an HeNB is added in this state will be a basic case.

In this case, it is considered that the L-GW 102 is managed by the MME 103 or the like in the EPC 202.

Therefore, an HeNB 111 newly added in the HeNB subsystem 201 inquires of the MME 103 about the address of the L-GW 102. After acquiring the IP address of the L-GW 102, the HeNB 111 establishes an Sxx interface as a logical interface with the L-GW 102.

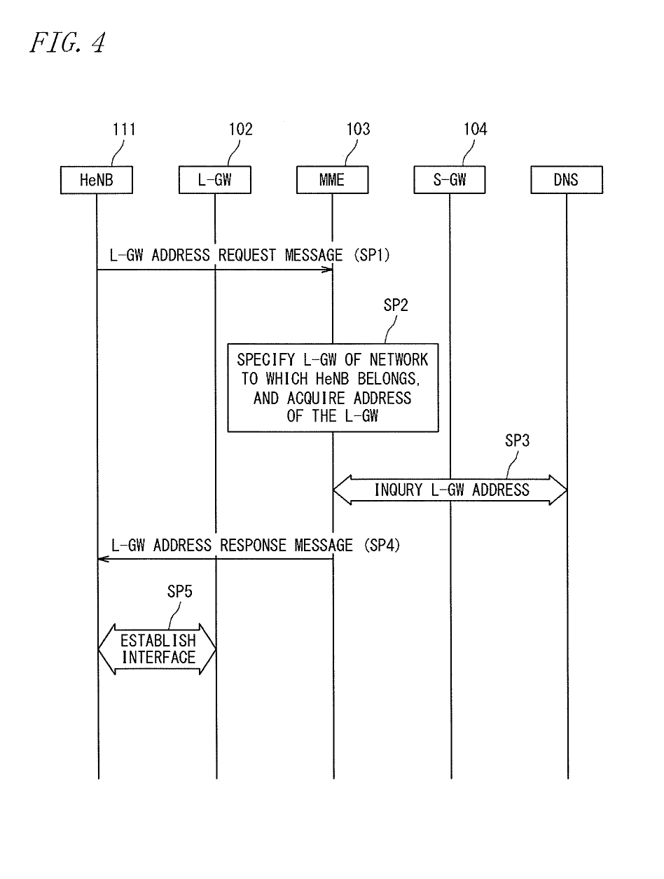

FIG. 4 is a diagram showing a sequence to establish an interface between the new HeNB and the L-GW in the wireless communication system according to Embodiment 1 of the present invention.

With reference to FIG. 4, first, the HeNB 111 transmits, to the MME 103, an L-GW address request message that is inquiry information for acquiring an address of an L-GW corresponding to the HeNB 111.

For example, the HeNB 111 includes, in the inquiry information, identification information for identifying the L-GW corresponding to the HeNB 111, and transmits the inquiry information to the MME 103. Specifically, information required for address resolution for the L-GW, such as the ID of the HeNB 111, APN (Access Point Name), CSG (Closed Subscriber Group) ID and the like are included as parameters in the L-GW address request message (step SP1).

Upon receiving the L-GW address request message from the HeNB 111, the MME 103 specifies the L-GW corresponding to the HeNB 111. That is, the MME 103 specifies the L-GW 102 in the HeNB subsystem 201 to which the HeNB 111 belongs, and acquires the address of the L-GW 102. For example, the MME 103 specifies the L-GW 102 corresponding to the HeNB 111, based on the APN and, if necessary, the CSG ID which are included in the L-GW address request message. Further, with reference to the ID of the HeNB 111 included in the L-GW address request message, the MME 103 determines whether the LIPA is applicable to the HeNB 111 (step SP2).

Further, the MME 103, if necessary, inquires of an address management device that manages the L-GW address, e.g., a DNS (Domain Name System) server or the S-GW 104 installed in the EPC 202, about the address of the L-GW 102, and acquires the address of the L-GW 102 (step SP3).

Next, the MME 103 transmits, to the HeNB 111, response information indicating the address of the L-GW 102, i.e., an L-GW address response message including the acquired address of the L-GW 102 as a parameter (step SP4).

Upon receiving the L-GW address response message from the MME 103, the HeNB 111 performs a procedure to establish communication connection using an Sxx interface with the L-GW 102. The HeNB 111 also performs a security process such as IPsec if necessary (step SP5).

Hereinafter, an LIPA connection establishment process in the wireless communication system according to Embodiment 1 of the present invention will be described.

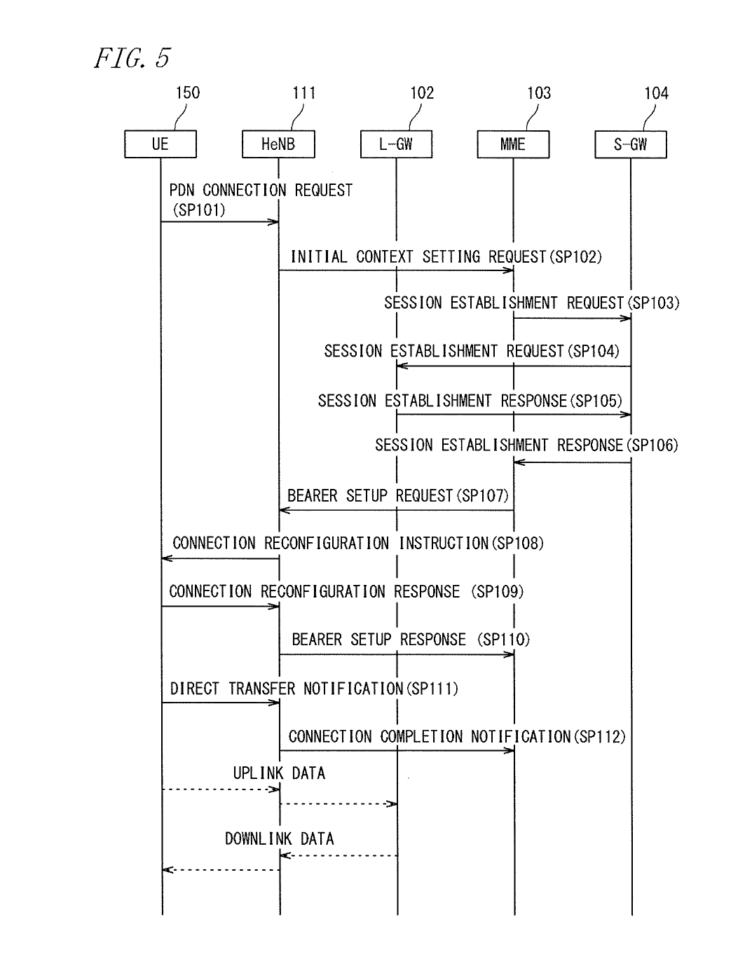

FIG. 5 is a diagram showing an example of a sequence to establish an LIPA connection in the wireless communication system according to Embodiment 1 of the present invention.

With reference to FIG. 5, first, the UE 150 transmits, to the HeNB 111, as access request information, a PDN (Packet Data Network) connection request that indicates an access request to the LAN 51 (step SP101).

Next, the HeNB 111 includes the address of the L-GW 102 indicated by the L-GW address response message received from the MME 103, in the access request information indicating the access request to the LAN 51 by the UE 150, and transmits the access request information to the MME 103. Specifically, upon receiving the PDN connection request from the UE 150, the HeNB 111 transmits, to the MME 103, as the access request information, an initial context setup request including the acquired address of the L-GW 102 as a parameter (step SP102).

Next, the MME 103 acquires, from the L-GW 102, an address allocated to the UE 150 by the L-GW 102 having the address indicated by the access request information, and notifies the UE 150 of the acquired address via the HeNB 111 (steps SP103 to SP107).

Specifically, when the MME 103 determines that the LIPA is applicable, based on the initial context setup request received from the HeNB 111, the MME 103 transmits, to the S-GW 104, a session establishment request indicating a request for allocation of a resource such as a local IP address (step SP103).

Next, the S-GW 104 transmits, to the L-GW 102, the session establishment request received from the MME 103 (step SP104).

Upon receiving the session establishment request from the S-GW 104, the L-GW 102 allocates the LIPA resource to the UE 150 if the addition of the UE 150 does not cause the number of UEs that are simultaneously accessible to the LAN 51 to exceed a predetermined number. For example, the L-GW 102 stores therein the correspondence between the identification information of the UE 150 indicated by the session establishment request and the local IP address, and adds 1 to the usage resource count value indicating the number of UEs currently using the LIPA resource. Then, the L-GW 102 transmits, to the S-GW 104, a session establishment response including the local IP address for the UE 150 (step SP105).

Next, the S-GW 104 transmits, to the MME 103, the session establishment response received from the L-GW 102 (step SP106).

Upon receiving the session establishment response from the S-GW 104, the MME 103 transmits, to the HeNB 111, a bearer setup request including the IP address allocated by the L-GW 102, and the like (step S107). The bearer setup request is a request to establish communication connection between an HeNB and a UE.

Upon receiving the bearer setup request from the MME 103, the HeNB 111 transmits an RRC connection reconfiguration indication to the UE 150 (step SP108).

Upon receiving the RRC connection reconfiguration indication from the HeNB 111, the UE 150 transmits an RRC connection reconfiguration response to the HeNB 101 (step SP109).

Upon receiving the RRC connection reconfiguration response from the UE 150, the HeNB 111 transmits a bearer setup response to the MME 103 (step SP110).

Next, the UE 150 transmits, to the HeNB 111, a direct transfer notification indicating that the UE 150 accesses the LAN 51 by using the LIPA function (step SP111).

Upon receiving the direct transfer notification from the UE 150, the HeNB 111 transmits a PDN connection completion notification to the MME 103 (step SP112).

Thus, the LIPA connection is established, which enables an IP access to each equipment in the LAN 51 directly via the HeNB 111 and the L-GW 102. That is, an IP packet transmitted from the UE 150 is transferred to the terminal device 161 in the LAN 51 via the HeNB 111 and the L-GW 102, and an IP packet transmitted from the terminal device 161 is transferred to the UE 150 via the L-GW 102 and the HeNB 111.

After the LIPA connection has been established, data such as an IP packet for access of the UE 150 to the LAN 51 need not be transmitted between the HeNB 111, and the MME 103 and the S-GW 104. Therefore, communication traffic on the external network side can be reduced.

By the way, in order to realize a function of continuing an LIPA connection even when an UE moves between HeNBs, an appropriate method is desired which allows a newly installed HeNB to acquire an IP address of an L-GW in an environment such as an intra-company system wherein a plurality of HeNBs are installed.

Meanwhile, in the wireless communication system according to Embodiment 1 of the present invention, the HeNB 111 transmits, to the MME 103, the inquiry information for acquiring the address of the L-GW corresponding to the HeNB 111.

Upon receiving the inquiry information from the HeNB 111, the MME 103 transmits, to the HeNB 111, the response information indicating the address of the L-GW 102.

The HeNB 111 transmits, to the MME 103, the initial context setup request in which the address of the L-GW 102 indicated by the response information received from the MME 103 is included in the access request information indicating the access request to the LAN 51 by the UE 150.

Then, the MME 103 acquires, from the L-GW 102, the address allocated to the UE 150 by the L-GW 102 having the address indicated by the access request information, and notifies the UE 150 of the acquired address via the HeNB 111.

As compared to the case where the newly installed HeNB broadcasts the inquiry information to other devices in the HeNB subsystem 201, the above configuration prevents an increase in the traffic caused by concurrent responses from the other devices. Further, by adopting the configuration using the MME, the L-GW address resolution can be performed more reliably.

Therefore, in the wireless communication system according to Embodiment 1 of the present invention, the wireless base station device can appropriately acquire the address of the internal network connection device connected between the wireless base station device and the internal network.

Further, in the wireless communication system according to Embodiment 1 of the present invention, the HeNB 111 includes, in the inquiry information, the identification information for identifying the L-GW corresponding to the HeNB 111, and transmits the inquiry information to the MME 103. Then, the MME 103 receives the inquiry information from the HeNB 111, and transmits, to the HeNB 111, based on the identification information, the response information indicating the address of the L-GW 102 corresponding to the HeNB 111.

The above configuration allows the MME to easily identify the L-GW corresponding to the HeNB as the transmission source of the L-GW address request message.

Further, in the wireless communication system according to Embodiment 1 of the present invention, the MME 103 receives the inquiry information from the HeNB 111, and acquires the address of the L-GW 102 corresponding to the HeNB 111 from the address management device for managing the address of the L-GW.

The above configuration enables resolution of the address of the L-GW without using a device in the HeNB subsystem 201 that is, for example, an environment on the customer side of the mobile communications carrier, thereby providing more appropriate communication services.

Further, the wireless communication system according to Embodiment 1 of the present invention includes the HeNB defined in the 3GPP, the L-GW defined in the 3GPP, and the MME defined in the 3GPP.

The above configuration allows the wireless base station device to appropriately acquire the address of the internal network connection device connected between the wireless base station device and the internal network in order to realize the LIPA function defined in the 3GPP.

The eNB 106 may perform a similar operation to the operation of the HeNB 111 according to Embodiment 1 of the present invention.

In 3GPP (Third Generation Partnership Project) SPEC TS22.220, femto cells and access modes thereof are described as follows. That is, a femto base station is customer premises equipment that connects a wireless terminal device connected via a wireless interface, to a mobile communications carrier network by using an IP backhaul.

Regarding the access modes of the femto cells, a femto base station in a closed access mode provides services to only associated CSG members. A femto base station in a hybrid mode provides services to associated CSG members and to non-CSG members. A femto base station in an open access mode operates as a normal base station.

Such a definition based on the 3GPP may be applied to the wireless communication system according to Embodiment 1 of the present invention.

Further, the following definitions may be applied in combination with or separately from the above definition.

A macro base station is a wireless base station device under the control of a communications carrier, and wireless base station devices that subscribe to the communications carrier are allowed to access the macro base station. Further, it is considered that a macro base station is basically not powered off.

On the other hand, a femto base station is a wireless base station device that is mainly installed in a personal or corporate building, and is likely to be moved or powered off depending on user's circumstances.

Further, the femto base station operates in any of the open, hybrid, and closed access modes. When the femto base station operates in the closed access mode, only registered members (terminals) are allowed to access the femto base station. When the femto base station operates in the closed access mode, the femto base station provides services to only the registered members. When the femto base station operates in the hybrid mode, the femto base station provides services to both the registered members and unregistered members, i.e., non-members. When the femto base station operates in the open access mode, the femto base station operates in the same manner as the macro base station.

Hereinafter, another embodiment of the present invention will be described with reference to the drawings. In the drawings, the same or corresponding parts are denoted by the same reference numerals, and will not be repeatedly described.

### Embodiment 2

Embodiment 2 relates to a wireless communication system in which the destination of inquiry about an address of an L-GW by the MME is changed from that in the wireless communication system according to Embodiment 1. The wireless communication system according to Embodiment 2 is identical to Embodiment 1 except for the content mentioned below.

In the wireless communication system according to Embodiment 2 of the present invention, the MME inquires of another HeNB in the HeNB subsystem about an address of an L-GW.

That is, the MME 103 receives inquiry information from the HeNB 111, and acquires the address of the L-GW 102 from the HeNB 101 that has already established communication connection using a predetermined interface, e.g., an Sxx interface, with the L-GW 102.

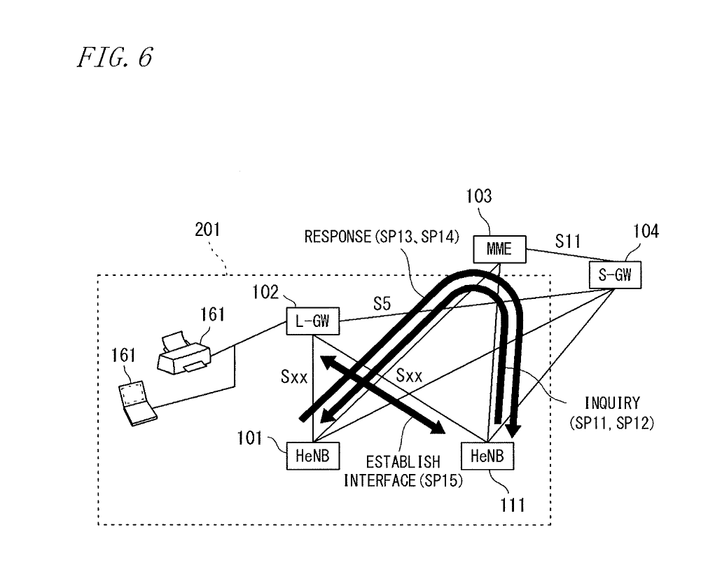

FIG. 6 is a diagram showing an interface establishment operation between a new HeNB and an L-GW in the wireless communication system according to Embodiment 2 of the present invention.

With reference to FIG. 6, when receiving an address inquiry from the newly added HeNB 111, the MME 103 requests the address of the L-GW 102 from another HeNB in the HeNB subsystem 201. Then, the MME 103 notifies the HeNB 111 as the request source, of the address of the L-GW 102 acquired from the another HeNB that has responded.

After acquiring the IP address of the L-GW 102, the HeNB 111 establishes communication connection using an Sxx interface with the L-GW 102.

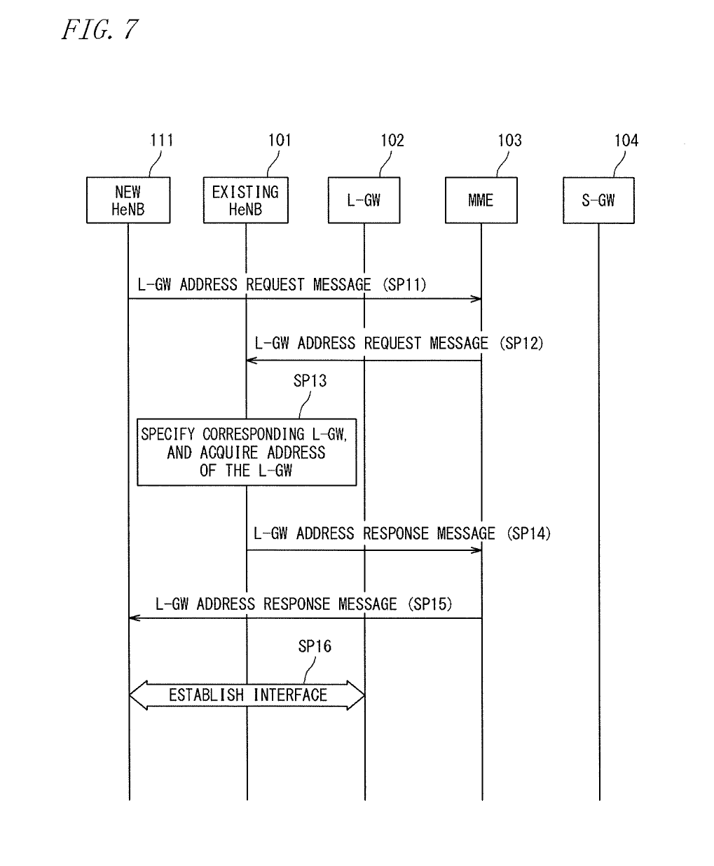

FIG. 7 is a diagram showing a sequence to establish an interface between a new HeNB and an L-GW in the wireless communication system according to Embodiment 2 of the present invention.

With reference to FIG. 7, first, the HeNB 111 transmits an L-GW address request message to the MME 103. Information required for address resolution for the L-GW, such as the ID of the HeNB 111, APN, CSG ID and the like are included as parameters in the L-GW address request message (step SP11).

Upon receiving the L-GW address request message from the HeNB 111, the MME 103 transmits the L-GW address request message to another HeNB in the HeNB subsystem 201 to which the HeNB 111 belongs, specifically, to the HeNB 101 that has already established communication connection using an Sxx interface with the L-GW 102. For example, with reference to the CSG ID included in the L-GW address request message, the MME 103 specifies the HeNB 101 having the same CSG ID as the HeNB 111 (step SP12).

Upon receiving the L-GW address request message from the MME 103, the HeNB 101 specifies the L-GW corresponding to the HeNB 111. That is, the HeNB 101 specifies the L-GW 102 in the HeNB subsystem 201 to which the HeNB 111 belongs, and acquires the address of the L-GW 102. For example, the HeNB 101 specifies the L-GW 102 corresponding to the HeNB 111, based on the APN and, if necessary, the CSG ID which are included in the L-GW address request message (step SP13).

Next, the HeNB 101 transmits, to the MME 103, an L-GW address response message including the address of the L-GW 102 as a parameter (step SP14).

Then, the MME 103 transmits the L-GW address response message received from the HeNB 101 to the HeNB 111 (step SP15).

Upon receiving the L-GW address response message from the MME 103, the HeNB 111 performs a procedure to establish communication connection using an Sxx interface with the L-GW 102. The HeNB 111 also performs a security process such as IPsec if necessary (step SP16).

In step SP12, the MME 103 may be configured to, without specifying the HeNB 101 corresponding to the HeNB 111, broadcast the L-GW address request message to all the HeNBs including the HeNB 101.

As described above, in the wireless communication system according to Embodiment 2 of the present invention, the MME 103 receives the inquiry information from the HeNB 111, and acquires the address of the L-GW 102 from the HeNB 101 that has already established communication connection using a predetermined logical interface, e.g., an Sxx interface, with the L-GW 102 corresponding to the HeNB 111.

The above configuration enables address resolution in the device in the HeNB subsystem 201 including the L-GW, thereby simplifying the address acquisition procedure.

Since the configurations and operations other than mentioned above are identical to those of the wireless communication system according to Embodiment 1, repeated description is not necessary.

The MME 103 may be configured to acquire the address of the L-GW 102 from an address management device that manages the L-GW address, such as a DNS (Domain Name System) server or the S-GW 104 installed in the EPC 202, according to need, before or after the acquisition of the address of the L-GW 102 from the HeNB 101.

Hereinafter, another embodiment of the present invention will be described with reference to the drawings. In the drawings, the same or corresponding parts are denoted by the same reference numerals, and will not be repeatedly described.

### Embodiment 3

Embodiment 3 relates to a wireless communication system in which the destination of inquiry about an address of an L-GW by the MME is changed from that in the wireless communication system of Embodiment 1. The wireless communication system of Embodiment 3 is identical to Embodiment 1 except for the content mentioned below.

In the wireless communication system according to Embodiment 3 of the present invention, a newly installed HeNB inquires of another HeNB in the HeNB subsystem about the address of the L-GW corresponding to the new HeNB.

That is, the HeNB 111 transmits inquiry information for acquiring the address of the L-GW 102, to the HeNB 101 with which the HeNB 111 has already established communication connection using a predetermined inter-base-station logical interface, e.g., an X2 interface, via the X2 interface.

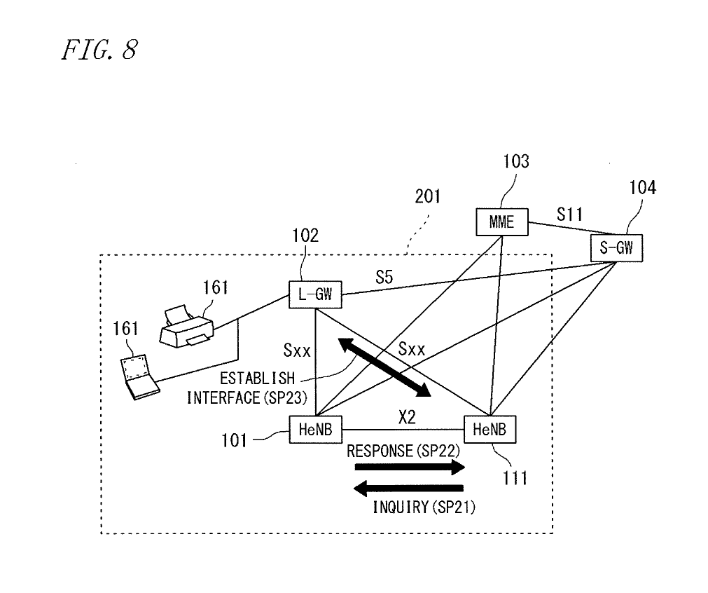

FIG. 8 is a diagram showing an interface establishment operation between a new HeNB and an L-GW in the wireless communication system according to Embodiment 3 of the present invention.

With reference to FIG. 8, the newly added HeNB 111 directly requests the address of the L-GW 102 from another HeNB 101 in the HeNB subsystem 201.

After acquiring the IP address of the L-GW 102, the HeNB 111 establishes communication connection using an Sxx interface with the L-GW 102.

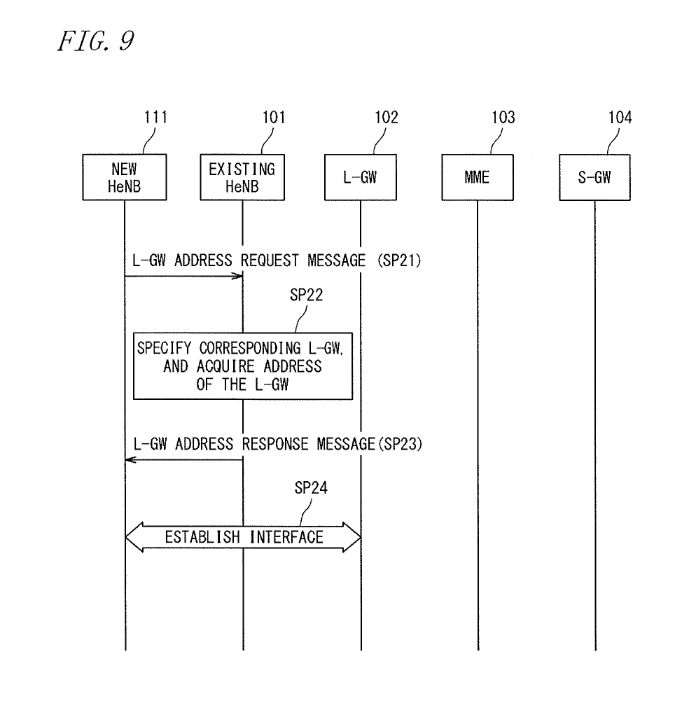

FIG. 9 is a diagram showing a sequence to establish an interface between a new HeNB and an L-GW in the wireless communication system according to Embodiment 3 of the present invention.

With reference to FIG. 9, first, the HeNB 111 transmits an L-GW address request message to the HeNB 101 with which the HeNB 111 has already established an X2 interface, via the X2 interface.

For example, the HeNB 111 includes, in inquiry information, identification information for identifying the L-GW corresponding to the HeNB 111, and transmits the inquiry information to the HeNB 101. Specifically, information required for address resolution for the L-GW, such as the ID of the HeNB 111, APN, CSG ID, and the like are included as parameters in the L-GW address request message.

For example, the HeNB 111 transmits the L-GW address request message to the HeNB 101 with which the HeNB 111 has already established communication connection using an X2 interface, and which belongs to the same subscriber group as the HeNB 111. That is, the HeNB 111 specifies the HeNB 101 that belongs to the same CSG ID as the HeNB 111 among HeNBs with which the HeNB 111 has already established X2 interfaces, and transmits the L-GW address request message to the HeNB 101 via the X2 interface (step SP21).

Upon receiving the L-GW address request message from the HeNB 111, the HeNB 101 specifies the L-GW corresponding to the HeNB 111. That is, the HeNB 101 specifies the L-GW 102 in the HeNB subsystem 201 to which the HeNB 111 belongs, and acquires the address of the L-GW 102. For example, the HeNB 101 specifies the L-GW 102 corresponding to the HeNB 111, based on the APN and, if necessary, the CSG ID which are included in the L-GW address request message (step SP22).

Next, the HeNB 101 transmits an L-GW address response message including the address of the L-GW 102 as a parameter, to the HeNB 111 via the X2 interface (step SP23).

Upon receiving the L-GW address response message from the HeNB 101, the HeNB 111 performs a procedure to establish communication connection using an Sxx interface with the L-GW 102. The HeNB 111 also performs a security process such as IPsec if necessary (step SP24).

In step SP21, the HeNB 111 may be configured to, without specifying the HeNB 101, broadcast the L-GW address request message to all the HeNBs including the HeNB 101 with which the HeNB 111 has already established the X2 interfaces.

Then, as in the wireless communication system according to Embodiment 1 of the present invention, the HeNB 111 includes the address of the L-GW 102 indicated by response information received from the HeNB 101, in access request information indicating an access request to the LAN 51 by the UE 150, and transmits the access request information to the MME 103.

The MME 103 acquires, from the L-GW 102, the address allocated to the UE 150 by the L-GW 102 having the address indicated by the access request information, and notifies the UE 150 of the acquired address via the HeNB 111.

As described above, in the wireless communication system according to Embodiment 3 of the present invention, the HeNB 111 transmits the inquiry information for acquiring the address of the L-GW, to the HeNB 101 with which the HeNB 111 has already established communication connection using a predetermined logical interface, i.e., the X2 interface, via the X2 interface. Upon receiving the inquiry information from the HeNB 111, the HeNB 101 transmits the response information indicating the address of the L-GW 102 to the HeNB 111 via the X2 interface.

The above configuration enables address resolution in the device in the HeNB subsystem 201 including the L-GW, thereby simplifying the address acquisition procedure.

Further, in the wireless communication system according to Embodiment 3 of the present invention, the HeNB 111 transmits the inquiry information to the HeNB 101 with which the HeNB 111 has already established communication connection using a predetermined logical interface, i.e., the X2 interface, and which belongs to the same subscriber group as the HeNB 111.

The above configuration prevents the inquiry information from being unnecessarily transmitted to many HeNBs.

Further, in the wireless communication system according to Embodiment 3 of the present invention, the HeNB 111 includes, in the inquiry information, the identification information for identifying the L-GW corresponding to the HeNB 111, and transmits the inquiry information to the HeNB 101. Upon receiving the inquiry information from the HeNB 111, the HeNB 101 transmits the response information indicating the address of the L-GW 102 corresponding to the HeNB 111, based on the identification information, to the HeNB 111.

The above configuration allows the HeNB to which the L-GW address request message has been transmitted, to easily identify the L-GW corresponding to the HeNB from which the L-GW address request message has been transmitted.

Since the configurations and operations other than mentioned above are identical to those of the wireless communication system according to Embodiment 1, repeated description is not necessary.

Hereinafter, another embodiment of the present invention will be described with reference to the drawings. In the drawings, the same or corresponding parts are denoted by the same reference numerals, and will not be repeatedly described.

### Embodiment 4

Embodiment 4 relates to a wireless communication system in which an interface establishment procedure between an existing HeNB and an L-GW is added, as compared to the wireless communication systems according to Embodiments 2 and 3. The wireless communication system of Embodiment 4 is identical to Embodiments 2 and 3 except for the content mentioned below.

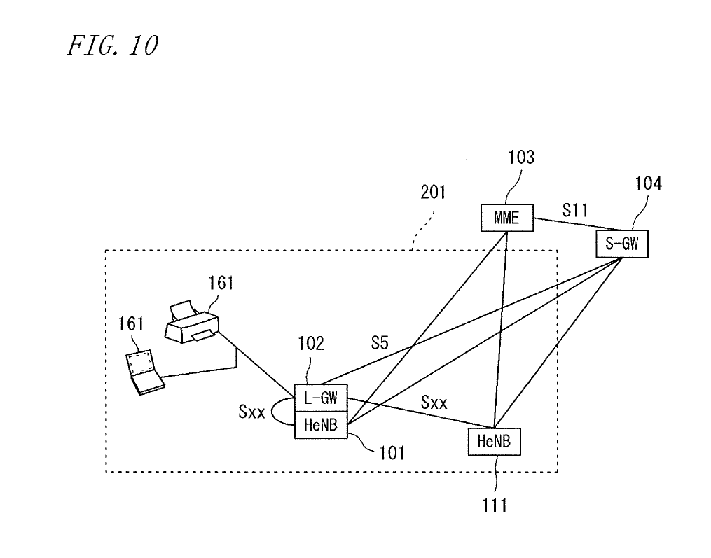

FIG. 10 is a diagram showing interface establishment between an existing HeNB and an L-GW in the wireless communication system according to Embodiment 4 of the present invention.

With reference to FIG. 10, in a state where in the HeNB subsystem 201 an L-GW 102 collocated in an HeNB 101 exists while other HeNBs do not exist, if an HeNB 111 is newly added, the collocated L-GW 102 is made standalone.

In this case, in the wireless communication system according to Embodiment 4 of the present invention, an Sxx interface is established between the existing HeNB 101 and the L-GW 102 as well as between the newly added HeNB 111 and the L-GW 102.

That is, in a state where the HeNB 101 is communicating with the L-GW 102 without establishing communication connection using a predetermined logical interface, e.g., an Sxx interface, if the HeNB 101 receives an inquiry about the address of the L-GW 102 from the HeNB 111 directly or via another device, the HeNB 101 establishes the communication connection with the L-GW 102.

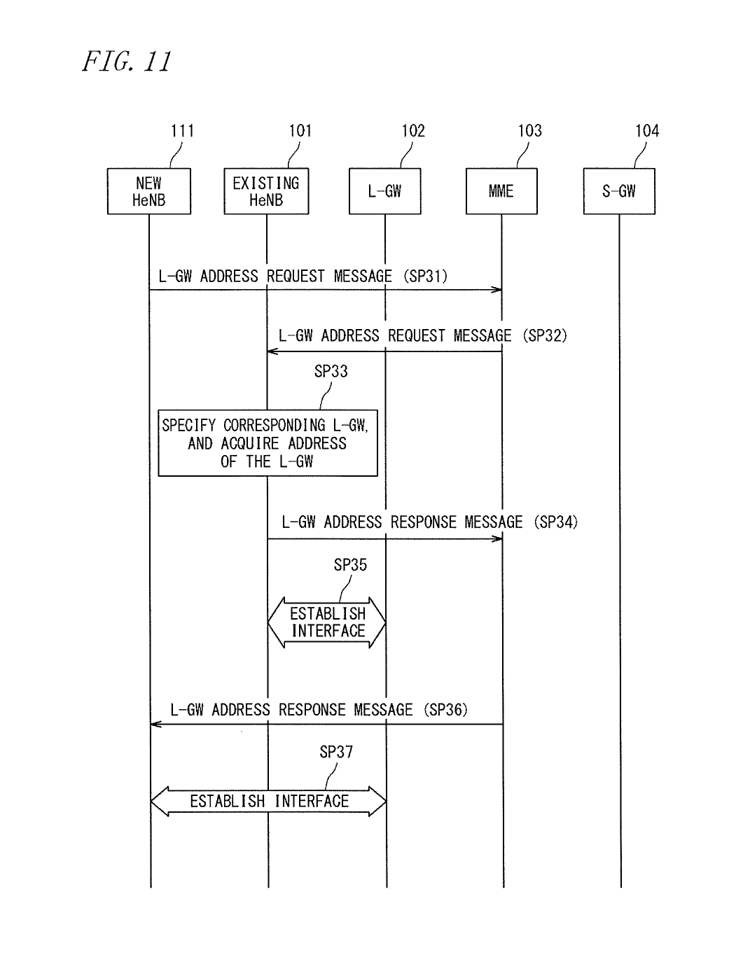

FIG. 11 is a diagram showing an example of a sequence to establish an interface between an HeNB and an L-GW in the wireless communication system according to Embodiment 4 of the present invention.

With reference to FIG. 11, first, the HeNB 111 transmits an L-GW address request message to the MME 103. Information required for address resolution for the L-GW, such as the ID of the HeNB 111, APN, CSG ID and the like are included as parameters in the L-GW address request message (step SP31).

Upon receiving the L-GW address request message from the HeNB 111, the MME 103 transmits the L-GW address request message to another HeNB in the HeNB subsystem 201 to which the HeNB 111 belongs, specifically, to the HeNB 101 that has already established communication connection using an Sxx interface with the L-GW 102. For example, the MME 103 specifies the HeNB 101 in which the same CSG ID as that of the HeNB 111 is set, with reference to the CSG ID included in the L-GW address request message (step SP32).

Upon receiving the L-GW address request message from the MME 103, the HeNB 101 specifies the L-GW corresponding to the HeNB 111. That is, the HeNB 101 specifies the L-GW 102 in the HeNB subsystem 201 to which the HeNB 111 belongs, and acquires the address of the L-GW 102. For example, the HeNB 101 specifies the L-GW 102 corresponding to the HeNB 111 based on the APN and, if necessary, the CSG ID which are included in the L-GW address request message (step SP33).

Next, the HeNB 101 transmits an L-GW address response message including the address of the L-GW 102 as a parameter to the MME 103 (step SP34).

Further, when receiving the L-GW address request message from the MME 103, the HeNB 101 performs a procedure to establish communication connection using an Sxx interface with the L-GW 102. The HeNB 111 also performs a security process such as IPsec if necessary (step SP35).

Then, the MME 103 transmits the L-GW address response message received from the HeNB 101 to the HeNB 111 (step SP36).

Upon receiving the L-GW address response message from the MME 103, the HeNB 111 performs a procedure to establish communication connection using an Sxx interface with the L-GW 102. The HeNB 111 also performs a security process such as IPsec if necessary (step SP37).

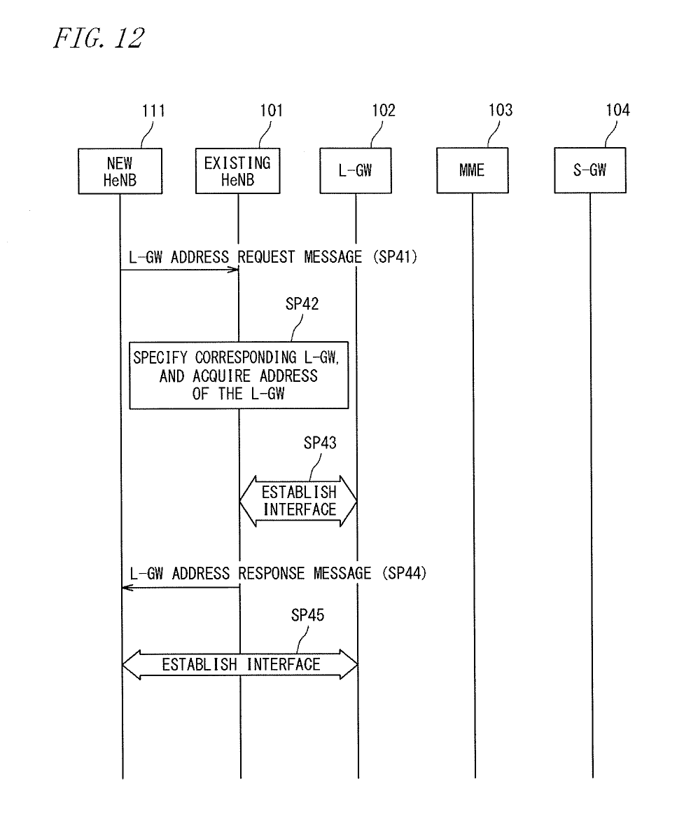

FIG. 12 is a diagram showing another example of a sequence to establish an interface between an existing HeNB and an L-GW in the wireless communication system according to Embodiment 4 of the present invention.

With reference to FIG. 12, first, the HeNB 111 transmits an L-GW address request message to an HeNB 101 with which the HeNB 111 has already established an X2 interface, via the X2 interface.

For example, the HeNB 111 includes, in inquiry information, identification information for identifying the L-GW corresponding to the HeNB 111, and transmits the inquiry information to the HeNB 101. Specifically, information required for address resolution for the L-GW, such as the ID of the HeNB 111, APN, CSG ID and the like, are included as parameters in the L-GW address request message.

For example, the HeNB 111 transmits the L-GW address request message to the HeNB 101 with which the HeNB 111 has already established communication connection using an X2 interface, and which belongs to the same subscriber group as the HeNB 111. That is, the HeNB 111 specifies the HeNB 101 that belongs to the same CSG ID as the HeNB 111 among HeNBs with which the HeNB 111 has already established X2 interfaces, and transmits the L-GW address request message via the X2 interface (step SP41).

Upon receiving the L-GW address request message from the HeNB 111, the HeNB 101 specifies the L-GW corresponding to the HeNB 111. That is, the HeNB 101 specifies the L-GW 102 in the HeNB subsystem 201 to which the HeNB 111 belongs, and acquires the address of the L-GW 102. For example, the HeNB 101 specifies the L-GW 102 corresponding to the HeNB 111 based on the APN and, if necessary, the CSG ID which are included in the L-GW address request message (step SP42).

Then, the HeNB 101 transmits an L-GW address response message including the address of the L-GW 102 as a parameter, to the HeNB 111 via the X2 interface (step SP43).

Further, when receiving the L-GW address request message from the HeNB 111, the HeNB 101 performs a procedure to establish communication connection with the L-GW 102 using an Sxx interface between an HeNB and an L-GW. The HeNB 111 also perform a security process such as IPsec if necessary (step SP44).

When receiving the L-GW address response message from the HeNB 101, the HeNB 111 performs a procedure to establish communication connection using an Sxx interface with the L-GW 102. The HeNB 111 also performs a security process such as IPsec if necessary (step SP45).

That is, in the wireless communication system according to Embodiment 4 of the present invention, in a case where the HeNB 101 is communicating with the L-GW 102 without establishing communication connection using a predetermined logical interface, i.e., an Sxx interface, if the HeNB 101 receives an inquiry about the address of the L-GW 102 from the HeNB 111 directly or via another device, the HeNB 101 establishes the communication connection with the L-GW 102.

As described above, in the case where the collocated L-GW is made standalone, communication connection using the same logical interface as that between the new HeNB and the L-GW is established also between the existing HeNB and the L-GW. Thereby, the communication procedure between each HeNB and an L-GW in the HeNB subsystem 201 can be unified, and the communication process can be simplified.

Since the configurations and operations other than mentioned above are identical to those of the wireless communication systems according to Embodiments 2 and 3, repeated description is not necessary.

The embodiment described above is to be considered in all respects as illustrative and not restrictive. The scope of the present invention is indicated by the appended claims rather than by the foregoing meaning, and all changes which come within the meaning and range of equivalency of the claims are therefore intended to be embraced therein.

### REFERENCE SIGNS LIST

51 LAN (internal network)

52 IP network (external network)

101, 111 HeNB (wireless base station device)

102 L-GW (internal network connection device)

103 MME (communication management device)

104, 105 S-GW (communication control device)

106 eNB (wireless base station device)

107 P-GW

150 UE (wireless terminal device)

201 HeNB subsystem

202 EPC (mobile communications carrier network)

301 wireless communication system

1. A communication system comprising:
a wireless base station device that transmits and receives radio signals to and from a wireless terminal device;
an internal network connection device connected between the wireless base station device and the internal network; and
a communication management device that manages the wireless terminal device, the wireless base station device, and the internal network connection device, wherein
the wireless base station device transmits inquiry information for acquiring an address of the internal network connection device to the communication management device,
the communication management device receives the inquiry information, and transmits response information indicating the address of the internal network connection device to the wireless base station device,
the wireless base station device includes the address of the internal network connection device indicated by the response information received from the communication management device, in access request information that indicates a request for access to the internal network by the wireless terminal device, and transmits the access request information to the communication management device, and
the communication management device acquires, from the internal network connection device, an address allocated to the wireless terminal device by the internal network connection device having the address indicated by the access request information, and notifies the wireless terminal device of the acquired address via the wireless base station device.

2. The communication system according to claim 1, wherein
the wireless base station device includes, in the inquiry information, identification information for identifying the internal network connection device corresponding to the wireless base station device, and transmits the inquiry information to the communication management device, and
the communication management device receives the inquiry information, and transmits, to the wireless base station device, based on the identification information, response information indicating the address of the internal network connection device corresponding to the wireless base station device.

3. The communication system according to claim 1, wherein
the communication management device receives the inquiry information, and acquires the address of the internal network connection device from an address management device for managing the address of the internal network connection device.

4. The communication system according to claim 1, wherein
the communication management device receives the inquiry information, and acquires the address of the internal network connection device from another wireless base station device that has already established communication connection using a predetermined logical interface with the internal network connection device.

5. A communication system, comprising:
a plurality of wireless base station devices that transmit and receive radio signals to and from wireless terminal devices;
an internal network connection device connected between the plurality of wireless base station devices and an internal network; and
a communication management device that manages the wireless terminal devices, the plurality of wireless base station devices, and the internal network connection device, wherein
one of the wireless base station devices transmits inquiry information for acquiring an address of the internal network connection device, to another one of the wireless base station devices that has already established communication connection using a predetermined logical interface with the wireless base station device, via the predetermined logical interface,
the another wireless base station device receives the inquiry information, and transmits response information indicating the address of the internal network connection device to the wireless base station device via the predetermined logical interface,
the wireless base station device includes the address of the internal network connection device indicated by the response information received from the another wireless base station device, in access request information indicating a request for access to the internal network by the wireless terminal device, and transmits the access request information to the communication management device, and
the communication management device acquires, from the internal network connection device, an address allocated to one of the wireless terminal devices by the internal network connection device having the address indicated by the access request information, and notifies the wireless terminal device of the acquired address via the wireless base station device.

6. The communication system according to claim 5, wherein
the wireless base station device transmits the inquiry information to another one of the wireless base station devices that has already established communication connection using a predetermined logical interface with the wireless base station device, and belongs to the same subscriber group as the wireless base station device.

7. The communication system according to claim 5, wherein
the wireless base station device includes, in the inquiry information, identification information for identifying the internal network connection device corresponding to the wireless base station device, and transmits the inquiry information to the another wireless base station, and
the another wireless base station device receives the inquiry information, and transmits, to the wireless base station device, based on the identification information, response information indicating the address of the internal network connection device corresponding to the wireless base station device.

8. The communication system according to claim 4, wherein
in a state where the wireless base station device is communicating with the internal network connection device without establishing communication connection using a predetermined logical interface, if the wireless base station device receives an inquiry about the address of the internal network connection device from another wireless base station device directly or via another device, the wireless base station device establishes the communication connection with the internal network connection device.

9. The communication system according to claim 1, wherein
the wireless base station device is an HeNB (Home e NodeB) defined in 3GPP, the internal network connection device is an L-GW (Local Gateway) defined in 3GPP, and the communication management device is an MME (Mobility Management Entity) defined in 3GPP.

10. A communication control method in a communication system comprising:
a wireless base station device that transmits and receives radio signals to and from a wireless terminal device;
an internal network connection device connected between the wireless base station device and the internal network; and
a communication management device that manages the wireless terminal device, the wireless base station device, and the internal network connection device,
the method comprising the steps of:
the wireless base station device transmitting inquiry information for acquiring an address of the internal network connection device to the communication management device;
the communication management device receiving the inquiry information, and transmitting response information indicating the address of the internal network connection device to the wireless base station device;
the wireless base station device including the address of the internal network connection device indicated by the response information received from the communication management device, in access request information indicating a request for access to the internal network by the wireless terminal device, and transmitting the access request information to the communication management device; and
the communication management device acquiring, from the internal network connection device, an address allocated to the wireless terminal device by the internal network connection device having the address indicated by the access request information, and notifying the wireless terminal device of the acquired address via the wireless base station device.

11. A communication control method in a communication system comprising:
a plurality of wireless base station devices that transmit and receive radio signals to and from wireless terminal devices;
an internal network connection device connected between the plurality of wireless base station devices and an internal network; and
a communication management device that manages the wireless terminal devices, the plurality of wireless base station devices, and the internal network connection device, the method comprising the steps of:
one of the wireless base station devices transmitting inquiry information for acquiring an address of the internal network connection device, to another one of the wireless base station devices that has already established communication connection using a predetermined logical interface with the wireless base station device, via the predetermined logical interface,
the another wireless base station device receiving the inquiry information, and transmitting response information indicating the address of the internal network connection device to the wireless base station device via the predetermined logical interface,
the wireless base station device including the address of the internal network connection device indicated by the response information received from the another wireless base station device, in access request information indicating a request for access to the internal network by the wireless terminal device, and transmitting the access request information to the communication management device, and
the communication management device acquiring, from the internal network connection device, an address allocated to one of the wireless terminal devices by the internal network connection device having the address indicated by the access request information, and notifying the wireless terminal device of the acquired address via the wireless base station device.

12. The communication system according to any one of claim 5, wherein
in a state where the wireless base station device is communicating with the internal network connection device without establishing communication connection using a predetermined logical interface, if the wireless base station device receives an inquiry about the address of the internal network connection device from another wireless base station device directly or via another device, the wireless base station device establishes the communication connection with the internal network connection device.

13. The communication system according to any one of claim 5, wherein
the wireless base station device is an HeNB (Home e NodeB) defined in 3GPP, the internal network connection device is an L-GW (Local Gateway) defined in 3GPP, and the communication management device is an MME (Mobility Management Entity) defined in 3GPP.
